(19) United States
(12) Patent Application Publication
(10) Pub. No.: US 2016/0031600 A1
(43) Pub. Date: Feb. 4, 2016

(54) Combination Container for Edible Products

(71) Applicant: Michael J. Windle, Louisville, KY (US)

(72) Inventor: Michael J. Windle, Louisville, KY (US)

(21) Appl. No.: 14/818,227

(22) Filed: Aug. 4, 2015

Related U.S. Application Data
(60) Provisional application No. 62/032,703, filed on Aug. 4, 2014.

(51) Int. Cl. B65D 25/04; A47J 47/02; B65D 30/22

(52) U.S. Cl. CPC B65D 25/04; B65D 31/12; A47J 47/02

(57) ABSTRACT

A combination container comprising at least one divider defining at least two chambers is provided for the packaging of two or more edible products that may be mixed prior to consumption. The combination container provides for more precise mixing of two or more edible products to desired proportions. The two or more edible products may include, for example, distinctly different cereal pieces desired to be mixed in specific ratios. Further, the combination container comprises separate and distinct tabs and in-cuts to allow for the independent opening and closing of each chamber.

### CROSS-REFERENCE TO RELATED APPLICATIONS

None.

### BACKGROUND

The subject embodiments relate to edible product containers and packaging, particularly relating to combination containers with at least one divider for the packaging of two or more edible products in the same container. In particular, the embodiments relate to the separation of opening and closing structures for each edible product chamber created by at least one divider.

Current edible product containers are comprised of a singular chamber and hold edible products that are pre-mixed or require mixing with another edible product held in a separate edible product container. Consequently, if desired mixture ratios are other than that of the pre-mixed ratios, then the consumer is required to remove and separate the edible products in a laborious process, or, otherwise, purchase multiple edible product containers to allow for the mixing of the desired ratios. Further, current edible product containers comprise a singular opening and closing structure, often in the form of a tab and in-cut, in the top of the container. Further still, some current edible product containers may include a secondary enclosure that aides in retaining freshness of the edible product, often in the form of a sealed bag or the like.

Consequently, consumers and edible product distributors are in need of an improved solution allowing for the mixture of desired ratios of two or more edible products. Moreover, consumers are in need of a convenient method for controlling mixtures of edible products within one container. Further still, edible product distributors are in need of an improved method of distributing edible products for customization by the consumer in a single package. Consequently, a combination container for edible products with at least one divider for holding two or more edible products and providing opening and closing structures for each individual chamber is desirable for both consumers and edible product distributors.

### SUMMARY OF THE EMBODIMENTS

The embodiments described herein meet the objectives stated in the previous section, and provide a combination container for edible products. The combination container comprises at least one pliable bag within the combination chamber that forms at least one pocket. Distinct edible products are placed within the pockets for storage. Each pocket also comprises a separate and distinct open-close structure that allows the pocket to be opened and closed separate of other pockets. Further, the at least one pliable bag is collectively comprised as a secondary enclosure that aides in retaining the freshness of the edible product.

Accordingly several advantages are to provide a combination container for edible products, to provide at least one divider to create at least two chambers for edible products, to provide separate and distinct open-close structures for each chamber, and to provide at least one secondary enclosure to retain freshness of the edible product. Still further advantages will become apparent from a study of the following descriptions.

### BRIEF DESCRIPTION OF THE DRAWINGS

The drawings and embodiments described herein are illustrative of multiple alternative structures, aspects, and features of the embodiments described and claimed herein, and they are not to be understood as limiting the scope of embodiments. It will be further understood that the drawing figures described and provided herein are not to scale, and that the embodiments are not limited to the precise arrangements and instrumentalities shown.

FIG. 1 is a perspective view of a combination container, according to multiple embodiments and alternatives.

FIG. 2 is a perspective view of a combination container and two pliable bags, according to multiple embodiments and alternatives.

FIG. 3 is a perspective view of a combination container and a divided singular pliable bag, according to multiple embodiments and alternatives.

FIG. 4 is a perspective view of a combination container with a divider, according to multiple embodiments and alternatives.

FIG. 5 is a perspective view of a combination container with a divider, according to multiple embodiments and alternatives.

### MULTIPLE EMBODIMENTS AND ALTERNATIVES

According to multiple embodiments and alternatives herein, a combination container for edible products and applications thereof shall be discussed in the present section.

A plurality of embodiments comprises a combination container for edible products and associated methods of producing and using. A combination container for edible products further comprises various structures, methods, and steps.

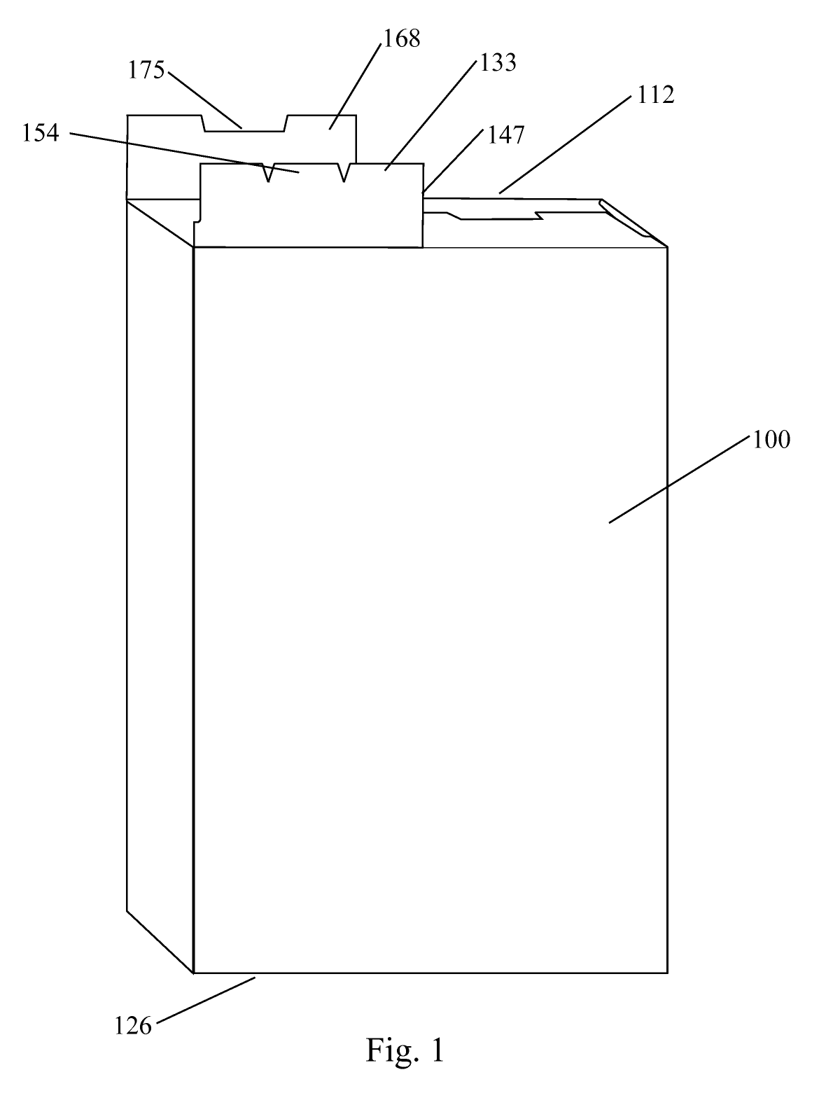

FIG. 1 shows a combination container 100 that is a four wall structure further comprising a top enclosure 112 and bottom enclosure 126. The shape of the combination container may include, for example, two parallel short walls and two parallel broad walls that are substantially wider the short walls, wherein the two parallel shorts walls are perpendicular to the two parallel broad walls, thus forming a rectangular cross-section. The top 112 and bottom 126 enclosures may include, for example, four flaps that fold together in such a way to allow for sealing the combination container for storage while also allowing for opening of the enclosure to dispense the edible product from the combination container.

Still referring to FIG. 1, the top enclosure 112 is positioned at the end of the four walls that is intended to be above the four walls when the combination container is vertically oriented. The first flap 133 of the enclosure corresponds to one of the broad walls and is the top-flap when the four flaps are folded together. The top-flap 133 comprises two distinct sides divided by a perforation 147 that allows each distinct side to be raised and lowered independent of the other distinct side. Each distinct side further comprises a tab 154 that protrudes beyond the main body of the flap such that each tab 154 may be inserted into a corresponding slot. A second flap 168 of the top enclosure corresponds to the second broad wall, which is the bottom-flap when the four flaps are folded together. The bottom-flap 168 comprises two matching distinct sides divided by a perforation 147 that allows each distinct side to be raised and lowered independent of the other distinct side. Further, each distinct side comprises, for example, an in-cut 175 or perforation that forms a slot that allows a matching tab 154 to be inserted from the top-flap 133. Accordingly, the remaining two flaps correspond to the two short walls and extend to partially overlap the top-flap and the bottom-flap, thus completing the enclosure.

Again referring to FIG. 1, the bottom enclosure 126 is positioned at the end of the four walls that is intended to be below the four walls when the combination container is vertically oriented. Similarly, the first flap of the bottom enclosure corresponds to a first broad wall. The first flap is placed on top of the three remaining flaps when all four flaps are folded together. Optionally, for example, the first flap does not contain any tabs or in-cuts as opposed to the top enclosure. Accordingly, the second flap of the bottom enclosure corresponds to a second broad wall. The second flap is placed below the three remaining flaps when all four flaps are folded together. Similar to the first flap, for example, the second flap of the bottom enclosure does not comprise any tabs or in-cuts. Further still, the remaining two flaps correspond to the two short walls and extend to partially overlap the footprint of the first flap and the second flap, wherein the combination of the first flap, the second flap, and the two remaining flaps complete the bottom enclosure and seal combination container.

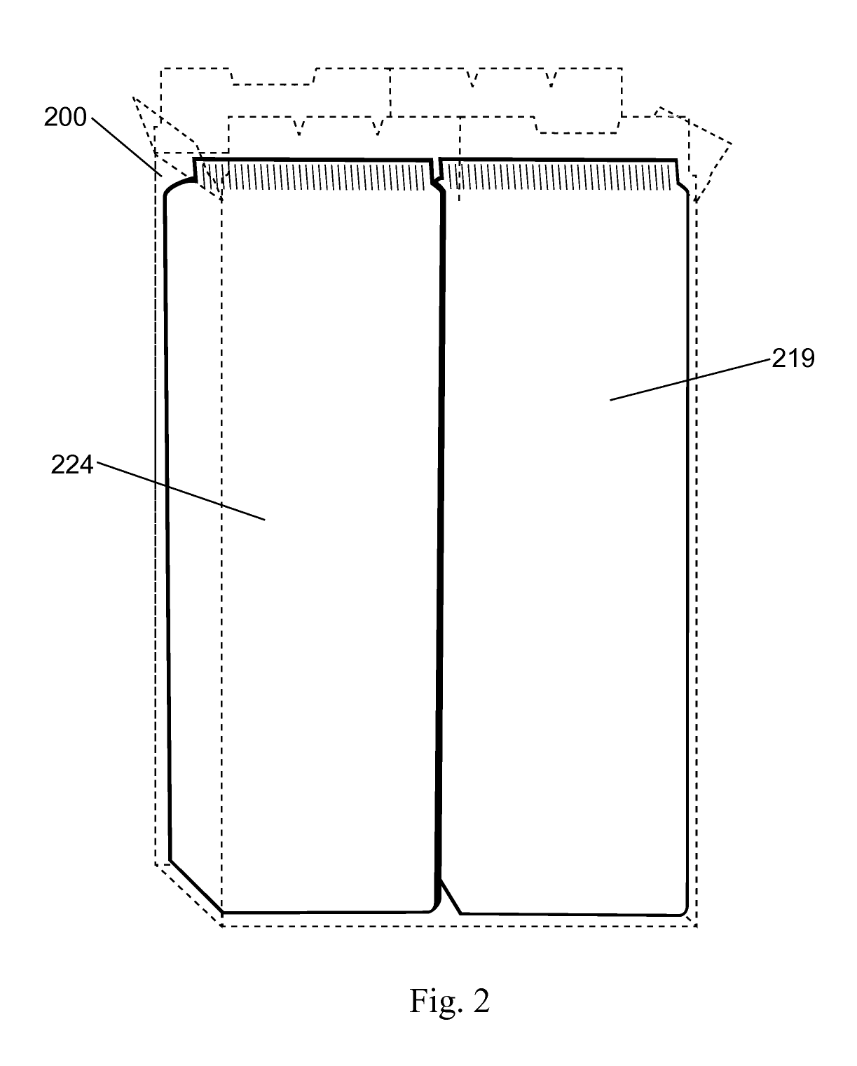

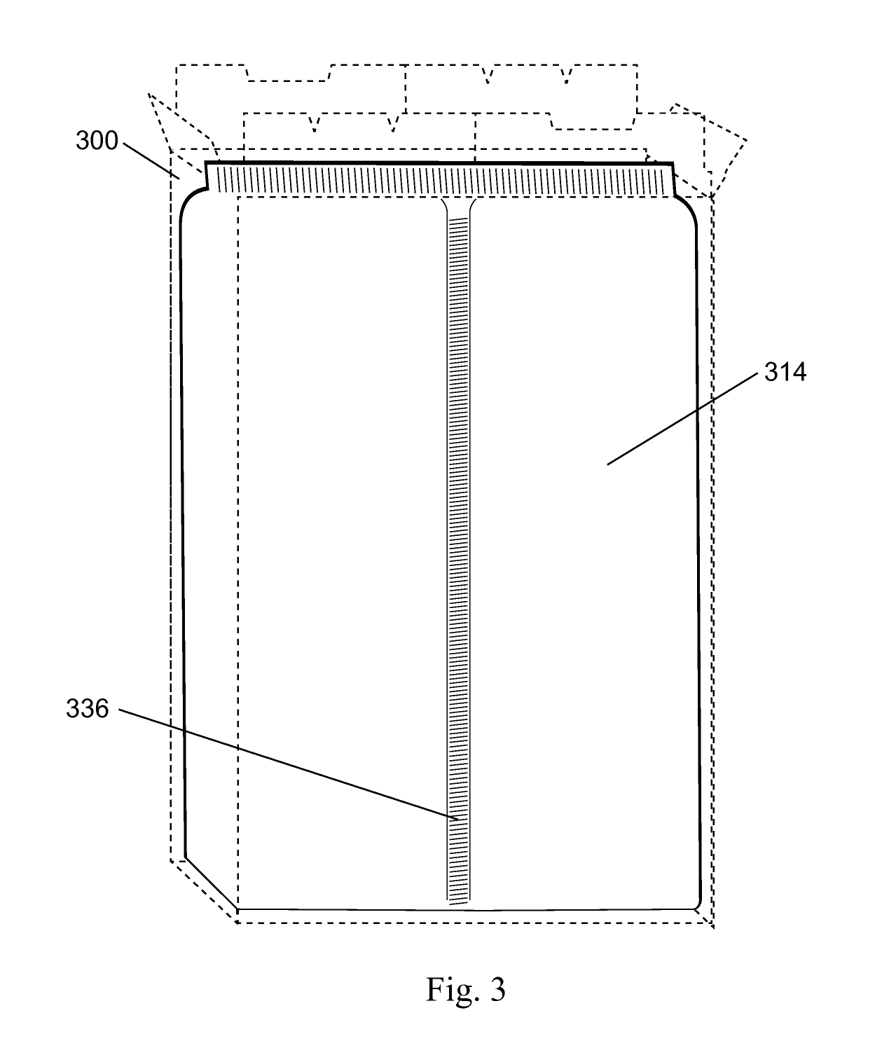

Further, the combination container for edible product comprises a secondary enclosure within the four walls, top enclosure, and bottom enclosure that define the bounds of the exterior of the combination container. Optionally, for example, the secondary enclosure comprises two separate and distinct enclosures within the exterior bounds of the combination container. As shown in FIG. 2, for example, the enclosures are pliable bags such that two separate pliable bags 219, 224 are contained within the exterior bounds of the combination container 200 and collectively form a secondary enclosure to retain and seal edible products. Accordingly, each pliable bag 219, 224 comprising the secondary enclosure corresponds to a distinct side of the top enclosure comprising its own open-close structure (e.g. tab and in-cut/perforation). Thus, the consumer may open and close separate sides of the top enclosure and access separate edible products contained within each pliable bag. Now referring to FIG. 3, for example, the secondary enclosure comprises a single pliable bag 314, wherein the pliable bag 314 comprises a dividing seal 336 within its bounds creating two separate pockets within the pliable bag. Accordingly, each pocket of the single pliable bag 314 may contain an edible product. Further, each pocket may correspond, for example, to a distinct side of the top enclosure such that each distinct side may be opened and closed to access and seal one of the two pockets of the single pliable bag.

Optionally, the top enclosure comprises two or more divisions such that two or more distinct sections are created; each includes, for example, a tab and in-cut for opening and closing each section. Further, the secondary enclosure is divided such that a corresponding number of pockets for retaining edible products comprise the secondary enclosure, thus allowing the consumer to access two or more edible products from the same combination container. Accordingly, the secondary enclosure in this embodiment may include, for example, separate pliable bags, a single pliable bag with sealed divisions creating pockets, and any combination thereof.

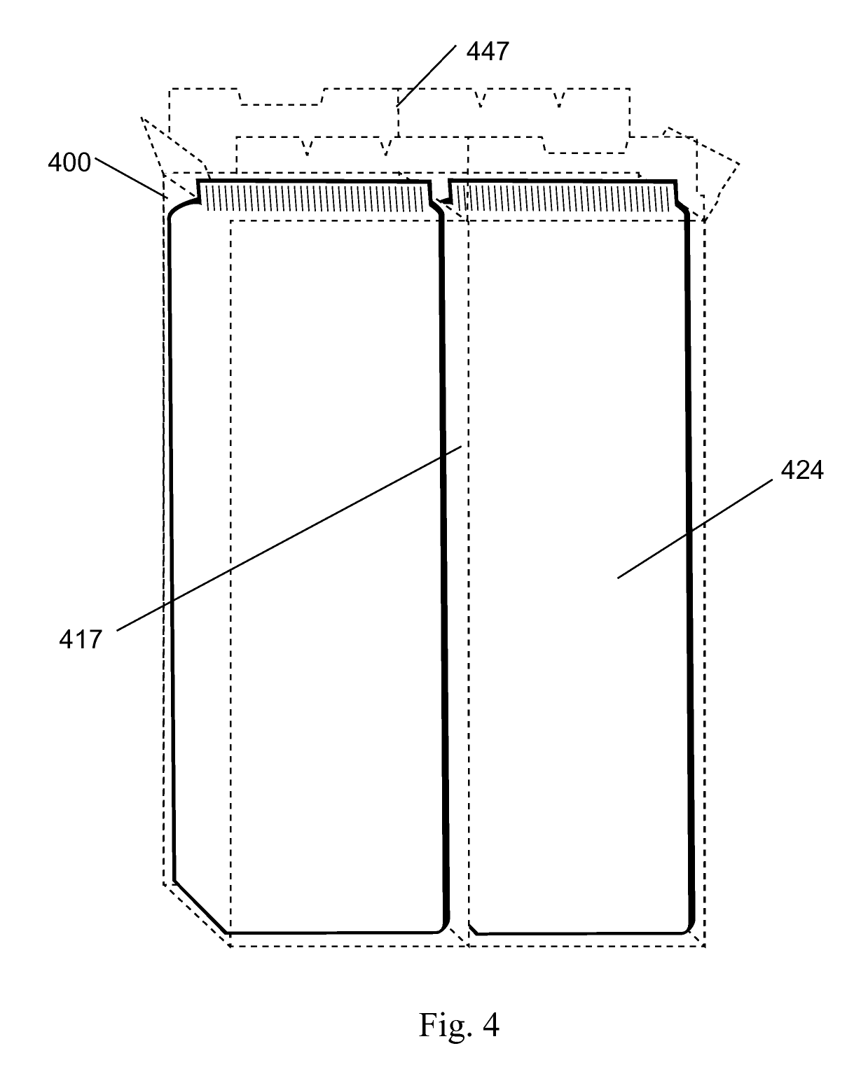

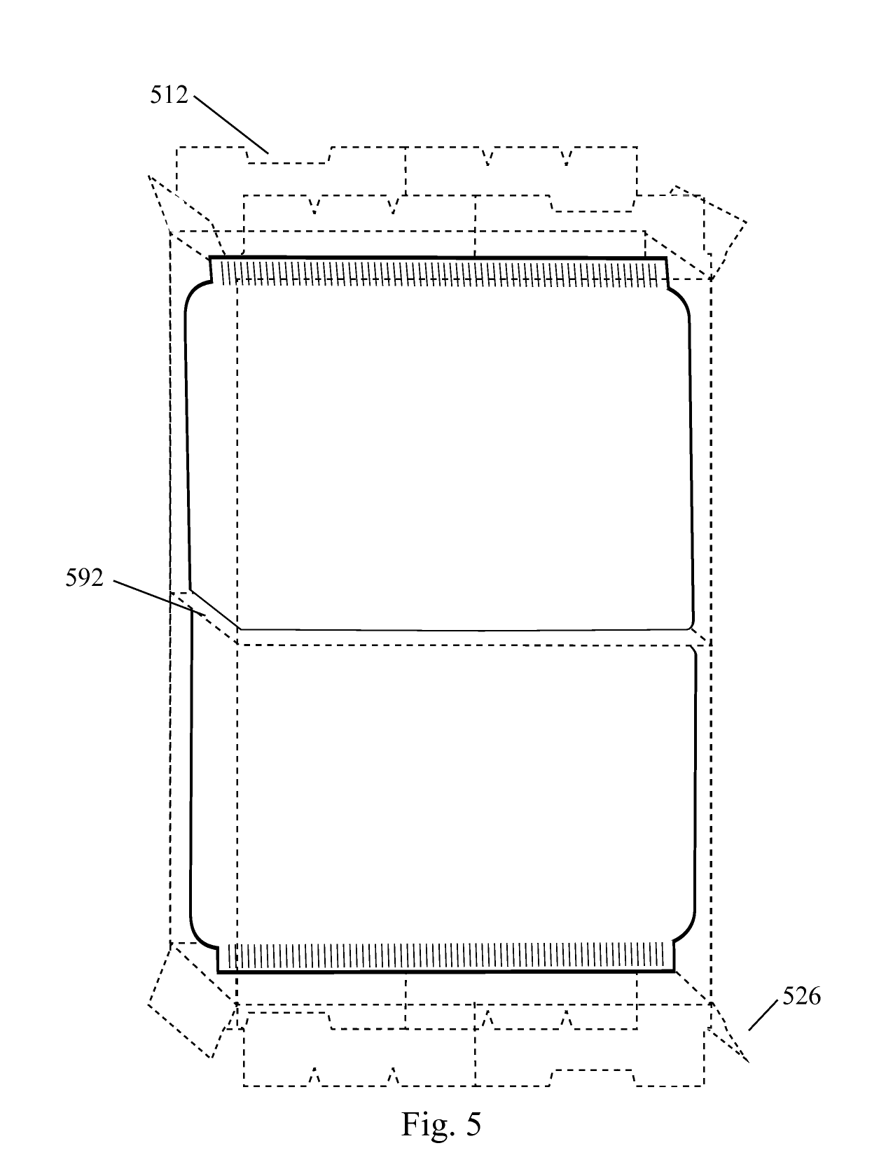

FIG. 4 illustrates a combination container 400 that further comprises at least one additional wall 417 that is positioned between two parallel sides such that separated chambers are created within the exterior bounds of the combination container 400. Further, said additional wall 417 corresponds to the location of a perforation 447 within the top enclosure such that distinct sides of the top enclosure correspond to a chamber. FIG. 4 further shows, for example, each chamber may contain at least one pliable bag 424 for the storage of edible product. FIG. 5 shows, for example, a dividing wall 592 positioned substantially between the top enclosure 512 and bottom enclosure 526 that is substantially parallel to the top enclosure and bottom enclosure, thus creating at least two separated chambers perpendicular to at least the four walls and, optionally, at least one additional wall parallel to at least two walls.

Furthermore, edible products contained within the combination container may include, for example, cereal products, snack foods, oatmeal, packaged unprepared foods, and other packaged edible products wherein two or more variants are desired to be combined prior to consumption. Further still, the combination container may be used to package other products not of an edible nature such that two or more variants are desired to be mixed in certain controllable ratios prior to use of the product. Accordingly, the combination container allows the consumer to purchase goods of two or more variants in a single container that allows for the mixture of the variants in a controllable desired ratio.

It will be understood that the embodiments described herein are not limited in their application to the specific details of the teachings and descriptions set forth, or as illustrated in the accompanying figures. Rather, it will be understood that the present embodiments and alternatives, as described and claimed herein, are capable of being practiced or carried out in various ways. The foregoing descriptions of several embodiments and alternatives are meant to illustrate, rather than to serve as limits on the scope of what has been disclosed herein. It will be understood by those having ordinary skill in the art that modifications and variations of these embodiments are reasonably possible in light of the above teachings and descriptions. Accordingly, the words and phrases used herein are for the purpose of description and should not be regarded as limiting. The use herein of “including,” “comprising,” “e.g.,” “containing,” or “having” and variations of those words is not meant to limit the scope of the embodiments, but rather is meant to encompass the items listed thereafter, and equivalents of those, as well as additional items.

What is claimed is:

1. A combination container for edible products, comprising:
a first wall having four edges wherein a first edge is substantially joined to one edge of a second wall;
a second wall having four edges wherein a first edge is substantially joined to one edge of said first wall and a second parallel edge is substantially joined to one edge of a third wall;
a third wall having four edges wherein a first edge is substantially joined to one edge of said second wall and a second parallel edge is substantially joined to one edge of a fourth wall;
a fourth wall having four edges wherein a first edge is substantially joined to one edge of said third wall and a second parallel edge is substantially joined to one edge of said first wall;
a first enclosure located on one end of said four walls having four flaps each substantially joined to a corresponding edge of one of said four walls wherein a first flap is the top-flap and comprises two distinct sides divided by a perforation, a second flap located opposite of said first flap and comprises two distinct sides divided by a perforation, and a third and fourth flap located opposite of each other; and
a second enclosure located opposite of said first enclosure on the other end of said four walls.

2. The combination container of claim 1, wherein said first wall and said third wall are substantially wider than said second wall and said fourth wall.

3. The combination container of claim 2, wherein said first flap of said first enclosure is substantially joined to the corresponding edge of said first wall.

4. The combination container of claim 1, wherein each distinct side of said first flap and said second flap both of said first enclosure can be raised or lowered independent of the other distinct side.

5. The combination container of claim 1, wherein each distinct side of said first flap of said first enclosure further comprises a tab that protrudes beyond the main body of said first flap.

6. The combination container of claim 1, wherein each distinct side of said second flap of said first enclosure further comprises an in-cut that forms a slot.

7. The combination container of claim 1, wherein each distinct side of said second flap of said first enclosure further comprises a perforation that forms a slot.

8. The combination container of claim 1, further comprising a secondary container enclosed by the bounds of said four walls, said first enclosure, and said second enclosure.

9. The combination container of claim 8, wherein said secondary container is comprised of two separate and distinct enclosures.

10. The combination container of claim 9, wherein each separate and distinct enclosure is a pliable bag such that two separate pliable bags are enclosed by the bounds of said four walls, said first enclosure, and said second enclosure and collectively form a secondary container.

11. The combination container of claim 10, wherein each of said two separate pliable bags corresponds to a distinct side of said first flap of said first enclosure.

12. The combination container of claim 8, wherein said secondary container is comprised of a singular pliable bag, wherein said pliable bag comprises a dividing seal within its bounds, thus creating two separate pockets within said pliable bag.

13. The combination container of claim 12, wherein each of said two separate pockets of said pliable bag corresponds to a distinct side of said first flap of said first enclosure.

14. The combination container of claim 1, further comprising at least one additional wall positioned between said second wall and said fourth wall, thus forming at least two chambers within the combination container.

15. The combination container of claim 14, wherein said additional wall corresponds to the location said perforation of said first flap of said first enclosure.

16. The combination container of claim 14, wherein each chamber contains at least one pliable bag.

17. The combination container of claim 1, further comprising a dividing wall positioned substantially between said first enclosure and said second enclosure, thus forming two separated chambers within the combination container.

18. The combination container of claim 17, wherein said dividing wall is positioned substantially parallel to said first enclosure and said second enclosure.

19. The combination container of claim 17, wherein each chamber contains at least one pliable bag.

20. The combination container of claim 17, further comprising at least one additional wall positioned between said second wall and said fourth wall that is perpendicular to said dividing wall.
